(19) United States
(12) Patent Application Publication
(10) Pub. No.: US 2014/0097042 A1
(43) Pub. Date: Apr. 10, 2014

(54) Motorized Extension Ladder

(71) Applicants: Brian Wright, Orangeville (CA); Brenda Wright, Orangeville (CA)

(72) Inventors: Brian Wright, Orangeville (CA); Brenda Wright, Orangeville (CA)

(21) Appl. No.: 14/047,953

(22) Filed: Oct. 7, 2013

Related U.S. Application Data
(60) Provisional application No. 61/710,094, filed on Oct. 5, 2012.

(51) Int. Cl. E06C 1/12

(52) U.S. Cl. CPC E06C 1/12
USPC 182/208

(57) ABSTRACT

A motorized extension ladder comprising a stationary first section, a moveable second section which is reversibly moveable from a proximate location to a distal location, a first cable pulley system with a first cable and first pulley to reversably move said moveable section from said proximate location to said distal location, and back, by a motor. The motor can be permanently affixed to the ladder, or operatively connected as required. A series of pulleys is provided which are moveable by rotation of a threaded rod, in order to cause the moveable section of the ladder to extend or retract. A motorized method for extending or retracting an extension ladder is provided.

### FIELD OF THE INVENTION

The present invention relates to the field of extension ladders, and in particular, relates to a motorized, or a motorizable extension ladder.

### BACKGROUND OF THE INVENTION

It can be laborious, taxing, and time consuming to raise and lower extension ladders using traditional rope systems. This usually entails pulling on a rope system to cause an inner, moveable ladder structure to be extended from an outer, stationary ladder structure, and then be held in place in the extended position using suitable rung-locking devices which connect the frame and/or rungs of the inner ladder to the rungs of the outer ladder, as the inner ladder is raised.

After use, the rung-locking devices can be released so that the inner, moveable ladder structure can be retracted.

However, extending the inner ladder can be difficult, particularly for longer ladders having a longer, and heavier, inner ladder structure. Moreover, balancing the ladder while extending the inner ladder structure can be awkward. Additionally, people can injure themselves when extending the ladder, before they even start their job.

In US 2012/0012426, an elevation device is described in which an moveable platform system is used to replace a ladder structure. However, this device has a fixed length, and is not suitable for use as a ladder.

U.S. Pat. No. 7,900,745 describes a ladder having a motor driven, moveable platform, but again, this device is of a fixed length.

U.S. Pat. No. 6,866,118 and U.S. Pat. No. 8,028,804 provide extendable ladders for accessing attics. However, these devices are fixed in place, at one end, and are intended to be extended a fixed distance. As such, there is no need for the locking systems of the type required in an extension ladder which is extendable to different lengths. Further, these systems use a cable winch-like systems which relies on cables being wound around a single pulley, which can lead to slippage or misalignment of the cable

In U.S. Pat. No. 5,590,739, a motor driven extendable stepladder is described using a locking system to control the extended height. However, this device relies on a motor driven sprocket gear which engages strip gears which run along the entire side of the inner ladder structure. As such, this arrangement is not suitable for existing ladder structures, and moreover, since the sprocket and strip gears are exposed, they can be easily damaged particularly, in construction applications or the like. This can leading to slippage of the inner ladder structure and/or other malfunctioning of the extension ladder.

To overcome these difficulties, it would be advantageous to provide a motorized extension ladder, or an extension ladder structure which can be adapted to be motorized, using current, pre-existing ladders and which incorporate and rely on current, existing ladder locking systems.

### SUMMARY OF THE INVENTION

The present invention describes a ladder. The device comprises an extension ladder that includes an electric motor and pulley. The device resembles a conventional extension ladder that includes multiple pulleys and a cable, rope, strap, or the like, that are adaptable to be attached to an electric motor. The device enables a user to raise and lower a ladder to the desired height with the electric motor and pulley assembly. This prevents people from having to use physically demanding, cumbersome, and dangerous manual rope systems currently used to raise and lower ladders, and reduces the amount of time it takes to set up and position a ladder.

Instead of a single pulley system, however, the present invention utilizes a moveable, multi-pulley system preferably driven by rotation of a threaded gear, so as to control the movement of the extension ladder.

Accordingly, it is a principal advantage of the present invention to provide a motorized extension ladder comprising a stationary first section, a moveable second section which is reversibly moveable from a proximate location to a distal location, a first cable pulley system with a first cable and first pulley to reversably move said moveable section from said proximate location to said distal location, and back, and which extension ladder is characterized by a motor, which is attached to, or which can be operatively attached to, said first cable of said first pulley system.

The motorized extension ladder of the present invention is further characterized in that the motor is connected to a second pulley system which comprises at least one pulley attached to a fixed pulley support, at least one pulley attached to a moveable pulley support, and a second cable operatively wound around said pulleys, and operatively connected to said first cable pulley system, and wherein said motor moves said movable pulley support, with respect to fixed pulley support.

In a general sense, the said motor can be a hydraulic or pneumatic ram, or the like, used to move said moveable pulley with respect to the fixed pulley. More preferably though, the motor is an electric or pneumatic motor which is operatively connected to, or connectable to, a rotatable threaded rod which rod is fixed at one end to said fixed pulley support, and connected to a threaded nut on said moveable pulley support, so that rotation of said threaded rod causes said moveable pulley support to move along said threaded rod, and thus pull or release said second cable.

The first cable and the second cable, are typically the same cable. Also, the term cable is intended to include any suitable cable-like products, and these can include ropes, wires, chains, strings, straps such as a 1-2 cm wide nylon strap, or the like, provided they have sufficient strength and flexibility for use in the present invention. Preferably, the cable is electrically non-conductive, or is coated so as to be non-conductive.

The second pulley system is preferably located within a housing affixed to the ladder. Most preferably, the housing is located on a side of the ladder, or is placed underneath a rung of the ladder;—preferably at a lower end of the stationary first section of the ladder. The housing can be made of any suitable material including metals or plastics, for example, and is also preferably electrically non-conductive.

Preferably, the ladder includes a locking mechanism or device which locks the moveable section in position between said proximate and distal location. Most preferably, the locking devices of the prior art, which include two moveable supports, with moveable clips, which allow the ladder to be extended and held, are provided, and these are still used in the fashion currently known by the skilled artisan. For example, the motor can be used to raise the moveable second section to a point where the locking mechanisms are activated, and then lowered to engage the locking mechanisms. After use, the moveable section is again raised to disengage the locking mechanism, and the moveable section lowered while the clips prevent the locking mechanism from engaging.

While these locking devices might be removed in place of the motor being used to hold the moveable second section of the ladder in place, it is strongly preferred that the current locking system of the extension ladder be maintained since the device of the present invention easily facilitates their use.

The motor can be an air driven motor, or can be an AC motor driven by connection to a suitable electrical source, such as house current, or the like. More preferably however, the motor is a battery driven DC motor. A typical motor would be a 6 to 24 volt motor, of the type commonly used in battery powered drills, and the like. Typically, the motor would be a 12 to 24 volt, variable speed, reversible drill, or drill motor.

The motor can be permanently affixed within the housing, or in one optional embodiment of the present invention, the second pulley system includes a spindle or socket, or the like, operatively connected to one end of the threaded rod, so that a electric drill or electric motor can be manually and temporarily attached to the threaded rod. Thus, the motor is not permanently affixed to the ladder, but can be used independent of the ladder, since it will be used only when the ladder is to be raised or lowered.

As such, in one preferred embodiment, the motor is permanently affixed to the ladder, and the motorized extension ladder comprises a stationary first section, a moveable second section which is reversibly moveable from a proximate location to a distal location, a first cable pulley system with a first cable and first pulley to reversably move said moveable section from said proximate location to said distal location, and back, and which extension ladder is characterized by a motor, which is attached to said first cable of said first pulley system, and wherein said motor is connected to a second pulley system which comprises at least one pulley attached to a fixed pulley support, at least one pulley attached to a moveable pulley support, and a second cable operatively wound around said pulleys, and operatively connected to said first cable pulley system, and wherein said motor moves said movable pulley support, with respect to fixed pulley support, and wherein said motor is an electric or pneumatic motor which is operatively connected to a rotatable threaded rod which rod is fixed at one end to said fixed pulley support, and connected to a threaded nut on said moveable pulley support, so that rotation of said threaded rod causes said moveable pulley support to move along said threaded rod.

In a further embodiment of the present invention, the motor is not permanently affixed to the ladder, but the ladder is adapted to operatively receive the motor, by use of a spindle or socket. In this embodiment, the present invention also provides a motorized extension ladder comprising a stationary first section, a moveable second section which is reversibly moveable from a proximate location to a distal location, a first cable pulley system with a first cable and first pulley to reversably move said moveable section from said proximate location to said distal location, and back, and which extension ladder is characterized by a spindle to which a motor can be connected, wherein said spindle is attached to said first cable of said first pulley system, and wherein said spindle is connected to a second pulley system which comprises at least one pulley attached to a fixed pulley support, at least one pulley attached to a moveable pulley support, and a second cable operatively wound around said pulleys, and operatively connected to said first cable pulley system, and wherein said spindle, when connected to said motor, moves said movable pulley support, with respect to fixed pulley support, and wherein said spindle is operatively connected to a rotatable threaded rod which rod is fixed at one end to said fixed pulley support, and connected to a threaded nut on said moveable pulley support, so that rotation of said threaded rod causes said moveable pulley support to move along said threaded rod.

In those instances where the motor is permanently affixed to the ladder, and is preferably located within the housing, the battery pack is preferably removeable so that it can be recharged away from the ladder. According to this approach, the ladder and/or housing, is preferably fitted with an adapter to allow a charged battery to be operatively connected to the motor, and removed or replaced for storage, or when the battery requires recharging. Alternatively, the battery can also be permanently attached to the ladder, and a recharger can be provided to allow the batter to be recharged, while still attached to the ladder.

For example, the battery could be located within the housing, within a rung of the ladder, or affixed to the side of the ladder.

The ladder can also be fitted with control buttons, particularly in the case where the motor is permanently affixed to the ladder, to control the speed and direction of the motor, and thus, the speed and direction of the ladder extension or retraction. In the case where the motor is an external motor, such as an external battery powered drill, the controls for the drill can be used to control the speed and direction of the ladder extension or retraction.

In accordance with most extension ladders of the prior art, the first pulley system typically includes having one end of the first cable being affixed to a lower end of the moveable second section of the ladder, and extending upward to a first pulley located at an upper end or portion of the stationary first section. After passing through the first pulley, the cable extends downward to the lower portion of the stationary first section.

In the prior art, this end of the cable is manual pulled and/or slowly released to extend or retract the second moveable portion of the ladder.

In the preferred embodiment of the present invention, the cable for the second pulley system enters the housing holding the second pulley system, which housing is preferably fitted vertically to the side of the ladder, or horizontally to the bottom of a rung at the lower portion of the first stationary section of the ladder. In the housing, the cable passes around a first pulley preferably located on the fixed pulley support, and then passes to the pulley located on said moveable pulley support. The cable can then pass back and forth between additional pulleys located on both the fixed and moveable pulley support structures. Once the cable has been passed through all of the pulleys, it is fixed at its end, and is preferably affixed to the fixed pulley support structure.

In the practise of the present invention, a second series of pulleys can also be added, and this second series of pulleys can be attached to a further first cable so that the ladder will include two first cables, and two first pulleys. These two series of first cables and first pulleys can be located on each side of the ladder, so as to not interfere with the ladder user.

Typically, for each cable, each of the fixed and moveable pulley support structures within the housing, will comprise between 2 and 6 pulleys each. More preferably, each of the fixed and moveable pulley supports will include between 3 and 5 pulleys per cable.

In a most preferred option, two first cables are used on the ladder, and each of said first cables is connected to a second pulley system within a housing, which comprises a pulley system having three pulleys on each of said fixed and moveable pulley supports, and on each side of the threaded rod.

The threaded rod is typically of a length between 25 and 150 cm in length, and typically has a diameter of between 1 and 3 cm. The thread size will be selected so as to be suitable for this application. When placed on the side of the ladder, the length of the threaded rod can vary depending on the ladder design parameters. For a longer ladder, a longer threaded rod can be used.

When placed below the rung of a ladder, a shorter length is usually required, but on ladders having a extended flared bottom section (typically to provide additional ladder stability), use of a longer threaded rod is possible.

The maximum extension length of the ladders of the present invention, will depend on the number of pulleys in the second pulley system, and the length between the fixed and moveable pulleys in the second pulley system. For example, if the change in distance from the fixed to the moveable pulley is 18 inches (0.45 m), using the threaded rod, then the total extension for a single pulley system would twice the distance, namely 36 inches (0.9 m), since the cable runs back and forth from one pulley to the other. For a system with three pulleys for each cable, and an 18 inch (0.45 m) threaded rod distance, the total extension possible would be 9 feet (2.7 m). As a further example, for a 1 foot (0.3 m) distance on the threaded rod, in a 6 pulley system, the total extension length would be 12 feet (3.6 m).

As such, within a limited area, the maximum extension length possible can be increased to acceptable extension lengths by adding additional pulleys.

The threaded rod is connected to the motor using any conventional approach, including a direct coupling, gears, or the like. Depending on the motor, a transmission with multiple gears to control the speed of the ladder might also be included.

As previously indicated, either end of the threaded rod might also be affixed to a spindle or socket so that an external motor (e.g. an electric drill or the like), can be operatively attached to the threaded rod.

The ladder of the present invention resembles a conventional extension ladder, and the term “extension ladder” refers to a ladders wherein one part of the ladder can be extended so as to increase the effective length of the ladder. The ladder can be constructed of aluminum, fiberglass, steel, wood, or another suitable material. The ladders of the present invention, are typically 8 to 16 ft in length (2.5 m to 5 m) in length, prior to extension, although longer or shorter extension ladders are not precluded.

### DETAILED DESCRIPTION OF THE INVENTION

The present application is primarily directed to the use of extension ladders, and the like. However, the skilled artisan will be aware that present invention can be used in other applications, included, for example, attic ladders, and the like. Use of the present system in an extension ladder have two (or more) moveable extension sections, is also not precluded, and the present invention is equally applicable in those, or other similar devices. Accordingly, while the present application is described with particular reference to extension ladders, the skilled artisan would be aware that the present application is equally applicable in other applications.

### BRIEF DESCRIPTION OF THE DRAWINGS

Embodiments of this invention will now be described by way of example only in association with the accompanying drawings in which:

FIG. 1 shows a view of an extension ladder of the prior art;

FIG. 2 shows a view of a motorized extension ladder of the present invention;

FIG. 3 shows a close-up view of the pulleys and cable; and

FIG. 4 shows a second view of the pulleys and cable.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the drawings in which a presently preferred embodiment of the invention will now be illustrated by way of example only. In the drawings, like reference numerals depict like elements.

It is expressly understood, however, that the drawings are for the purpose of illustration and description only and are not intended as a definition of the limits of the invention. Also, unless otherwise specifically noted, all of the features described herein may be combined with any of the above aspects, in any combination.

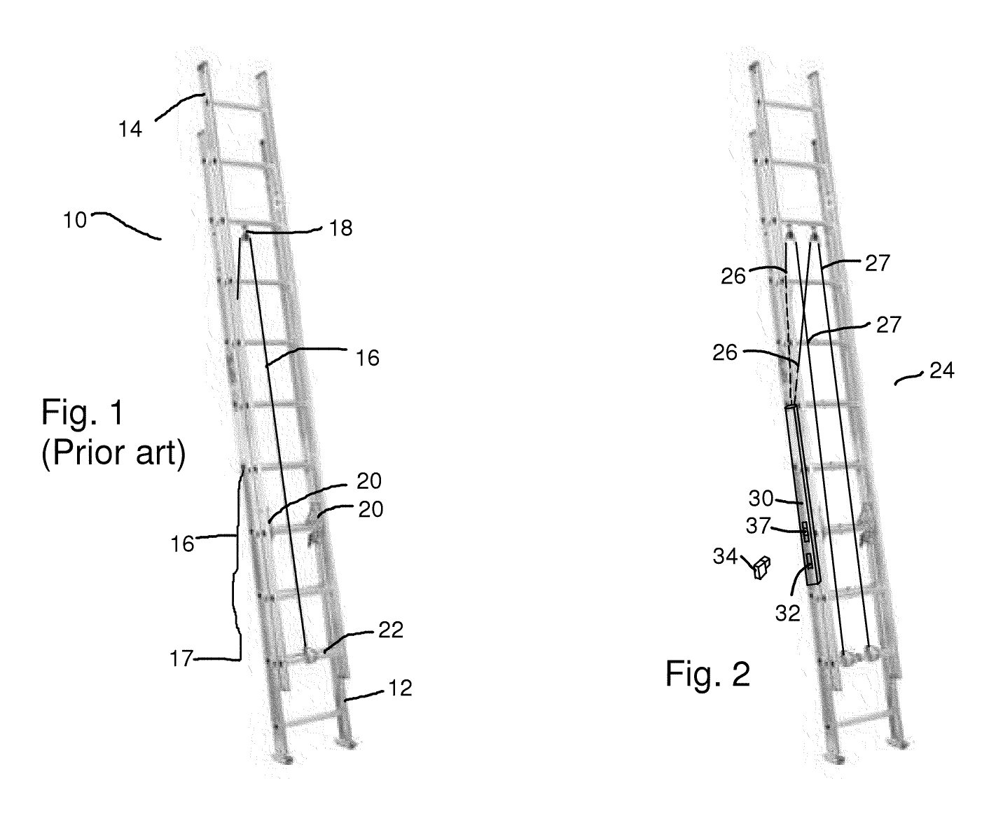

Referring now to FIG. 1, there is shown a view of the an extension ladder 10 of the prior art having a stationary first section 12, a moveable second section 14, a first cable 16, a first pulley 18, and showing locking mechanisms 20. The first cable is connected at a lower rung 22 of the moveable second section 14, and passes through a first pulley 18, located near the top of stationary first section 12. By pulling on the end 17 of cable 16, the second moveable section 14 is extended.

In FIG. 2, there is shown a ladder 24 of the present invention wherein a housing 30 is affixed to the side of present invention in use. The ends 26 of two first cables 27, are now fed into housing 30. Within housing 30 a series of pulleys and cables are provided. Housing 30 also includes an adapter 32 which receives a battery pack 34, which can be charged away from the ladder using a suitable battery recharger (not shown), and a series of operational control buttons 37 (e.g. up/down etc).

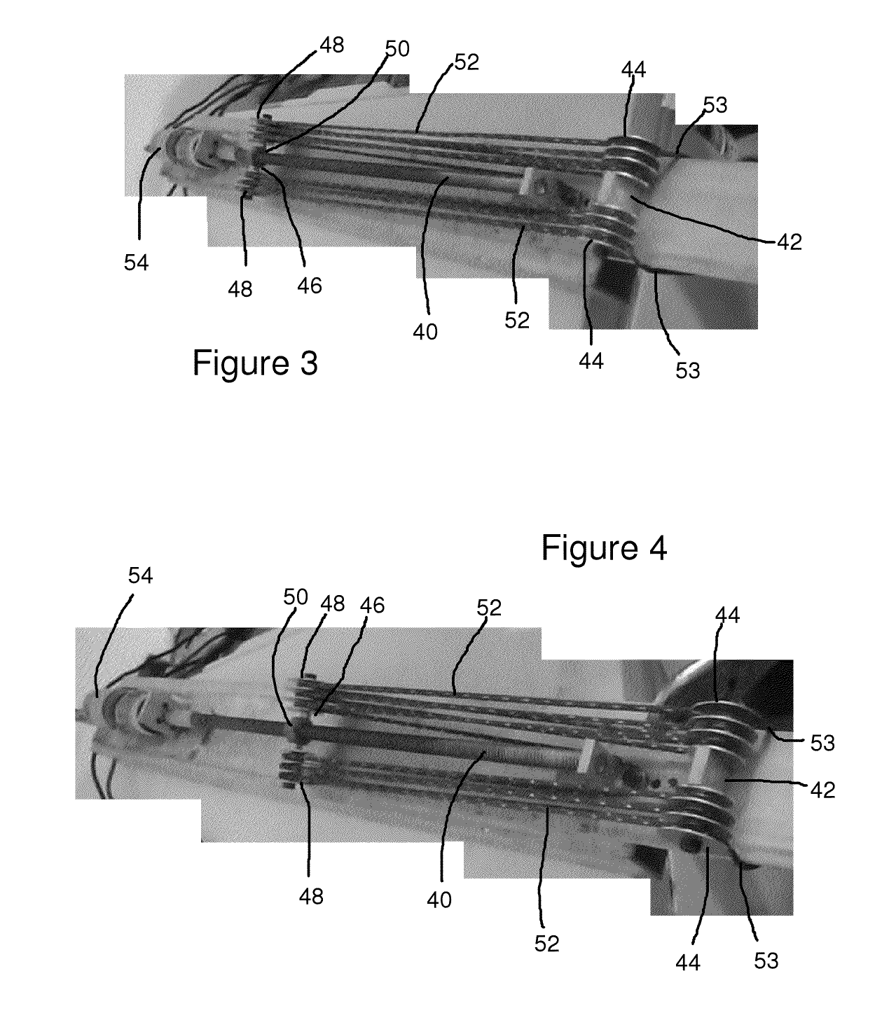

The details of a pulleys and cables inside of housing 30 are shown in FIGS. 3 and 4. In this example, three pulleys are provided on each side of threaded rod 40, on each of the moveable and fixed pulley support structures. A threaded rod 40 is shown together with a fixed pulley support structure 42, to which a series of pulleys 44 are attached. At the other end of threaded rod 40, is a moveable pulley support structure 46, also having a series of pulleys 48. Moveable pulley support structure 46 also includes a threaded nut 50, so that rotation of threaded rod 40 causes threaded nut 50, and thus moveable pulley structure 46, to move one way or the other. As a result of this movement, cables 52 which are provided between pulleys 44 and 48, pull or release cable into or from the housing 30, and thus, increase or decrease the length of the first cables 27. This causes the moveable second section 14 of ladder 24 to be raised or lowered.

In FIG. 3, two ends 53 of cable 52 exit the housing to be connected to the two first cables 27. In practise, first cables 27 are the same cables as cables 52.

A motor 54 is shown attached to the threaded rod 40, and motor 54 can be operated to rotate threaded rod 40 in one direction or the other, at any appropriate speed.

Motor 54 can be permanently affixed to threaded rod 40, as shown in FIG. 3, or can be removed and replaced with a spindle or socket (not shown) at either end of threaded rod 40, to which a suitable motor can be connected.

In FIG. 4, a view of the same pulley arrangement of FIG. 3 is shown. In FIG. 3, the moveable support structure 46 is essentially fully extended to the distal end of threaded rod 40, and this causes the moveable second section of the ladder to be fully extended. In FIG. 4, motor 54 has been activated to move the moveable support structure 46 towards the fixed support structure 42, and thus release additional cable 52 from housing 30, allowing the second movable section of the ladder to be lowered to a partially retracted position. Once moveable support structure 46 is moved to the proximate end of threaded rod 40, the moveable second section should be completely lowered to its retracted position.

The present invention thereby provides a motorized extension ladder 24 that can be automatically raised and lowered as needed, and which features an integrated electric motor and pulley assembly that raises and lowers the climbing apparatus to a desired height.

The electric motor controls the pulley assembly and cable to move the ladder up and down as needed. The motor may be powered by a rechargeable battery, and mounted to the side rail or back side of the ladder. The size of the motor and pulley assembly may vary, depending on the size of the ladder.

In operation, a user can carry the ladder to a desired location in a retracted position. The ladder can be positioned as required in a desired location. The user then activates the control buttons, which controls the motor, pulleys, and cable, thereby causing the ladder to extend. When the desired height is reached, the user can release the button. The user can climb the latter, and perform the desired task as needed. When complete, the user can raise the ladder to a higher height for additional work, or can lower the ladder if work is complete. The ladder can then be taken down and stored for later use. In this way, the present invention provides people with an easy and convenient way to electronically raise and lower a ladder.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

Thus, it is apparent that there has been provided, in accordance with the present invention, a motorized, or motorizable extension ladder, which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps. Further, the invention illustratively disclosed herein suitably may be practiced in the absence of any element which is not specifically disclosed herein.

Moreover, words such as “substantially” or “essentially”, when used with an adjective or adverb is intended to enhance the scope of the particular characteristic; e.g., substantially planar is intended to mean planar, nearly planar and/or exhibiting characteristics associated with a planar element.

Further, use of the terms “up”, “down”, “raised”, “lowered”, “extended” or “retracted, are intended to be applied to the ladder of the present invention, when used in its ordinary arrangement and configuration.

Also, while this discussion has addressed prior art known to the inventor, it is not an admission that all art discussed is citable against the present application.

What is claimed is:

1. A motorized extension ladder comprising a stationary first section, a moveable second section which is reversibly moveable from a proximate location to a distal location, a first cable pulley system with a first cable and first pulley to reversably move said moveable section from said proximate location to said distal location, and back, and which extension ladder is characterized by a motor, which is attached to, or which can be operatively attached to, said first cable of said first pulley system.

2. A motorized extension ladder as claimed in claim 1 wherein said motor is connected to a second pulley system which comprises at least one pulley attached to a fixed pulley support, at least one pulley attached to a moveable pulley support, and a second cable operatively wound around said pulleys, and operatively connected to said first cable pulley system, and wherein said motor moves said movable pulley support, with respect to fixed pulley support.

3. A motorized extension ladder as claimed in claim 1 wherein said motor is an electric or pneumatic motor which is operatively connected to, or connectable to, a rotatable threaded rod which rod is fixed at one end to said fixed pulley support, and connected to a threaded nut on said moveable pulley support, so that rotation of said threaded rod causes said moveable pulley support to move along said threaded rod, and thus pull or release said second cable.

4. A motorized extension ladder as claimed in claim 2 wherein said first cable and the second cable, are typically the same cable.

5. A motorized extension ladder as claimed in claim 1 wherein said first and second cable are ropes, wires, chains, strings, or straps.

6. A motorized extension ladder as claimed in claim 1 wherein said second pulley system is located within a housing affixed to the ladder.

7. A motorized extension ladder as claimed in claim 6 wherein said housing is located on a side of the ladder, or is placed underneath a rung of the ladder.

8. A motorized extension ladder as claimed in claim 1 wherein said ladder also comprises a locking device which locks the moveable section in position between said proximate and distal location.

9. A motorized extension ladder as claimed in claim 1 wherein said motor is a battery driven DC motor.

10. A motorized extension ladder as claimed in claim 1 wherein said battery driven DC motor is connected to a battery pack, and wherein said battery pack is removeable for recharging.

11. A motorized extension ladder as claimed in claim 2 wherein said second cable passes around a first pulley located on the fixed pulley support, and then passes to the pulley located on said moveable pulley support.

12. A motorized extension ladder as claimed in claim 11 wherein said cable additionally passes back and forth between additional pulleys located on both the fixed and moveable pulley support structures.

13. A motorized extension ladder as claimed in claim 12 wherein a second series of pulleys is added.

14. A motorized extension ladder as claimed in claim 11 wherein, for each cable, each of the fixed and moveable pulley support structures will include between 2 and 6 pulleys each.

15. A motorized extension ladder as claimed in claim 14 wherein each of the fixed and moveable pulley supports will include between 3 and 5 pulleys each.

16. A motorized extension ladder as claimed in claim 1 wherein said threaded rod has a length of between 25 and 150 cm in length

17. A motorized extension ladder comprising a stationary first section, a moveable second section which is reversibly moveable from a proximate location to a distal location, a first cable pulley system with a first cable and first pulley to reversably move said moveable section from said proximate location to said distal location, and back, and which extension ladder is characterized by a motor, which is attached to said first cable of said first pulley system, and wherein said motor is connected to a second pulley system which comprises at least one pulley attached to a fixed pulley support, at least one pulley attached to a moveable pulley support, and a second cable operatively wound around said pulleys, and operatively connected to said first cable pulley system, and wherein said motor moves said movable pulley support, with respect to fixed pulley support, and wherein said motor is an electric or pneumatic motor which is operatively connected to a rotatable threaded rod which rod is fixed at one end to said fixed pulley support, and connected to a threaded nut on said moveable pulley support, so that rotation of said threaded rod causes said moveable pulley support to move along said threaded rod.

18. A motorized extension ladder as claimed in claim 16 wherein said motor is a 12 to 24 volt, variable speed, reversible drill motor.

19. A motorized extension ladder comprising a stationary first section, a moveable second section which is reversibly moveable from a proximate location to a distal location, a first cable pulley system with a first cable and first pulley to reversably move said moveable section from said proximate location to said distal location, and back, and which extension ladder is characterized by a spindle to which a motor can be connected, wherein said spindle is attached to said first cable of said first pulley system, and wherein said spindle is connected to a second pulley system which comprises at least one pulley attached to a fixed pulley support, at least one pulley attached to a moveable pulley support, and a second cable operatively wound around said pulleys, and operatively connected to said first cable pulley system, and wherein said spindle, when connected to said motor, moves said movable pulley support, with respect to fixed pulley support, and wherein said spindle is operatively connected to a rotatable threaded rod which rod is fixed at one end to said fixed pulley support, and connected to a threaded nut on said moveable pulley support, so that rotation of said threaded rod causes said moveable pulley support to move along said threaded rod.

20. A motorized extension ladder as claimed in claim 19 wherein said motor is a 12 to 24 volt, variable speed, reversible drill.
